(19) United States
(12) Patent Application Publication
(10) Pub. No.: US 2016/0085919 A1
(43) Pub. Date: Mar. 24, 2016

(54) HEALTHCARE DATA MANAGEMENT TOOL

(71) Applicants: James Martin Sohr, Nashville, TN (US); Mark Gerhard Thienel, Nashville, TN (US); William Montgomery Butler, St. Petersburg, FL (US)

(72) Inventors: James Martin Sohr, Nashville, TN (US); Mark Gerhard Thienel, Nashville, TN (US); William Montgomery Butler, St. Petersburg, FL (US)

(73) Assignee: ADVENT HEALTH PARTNERS, INC., Nashville, TN (US)

(21) Appl. No.: 14/858,265

(22) Filed: Sep. 18, 2015

Related U.S. Application Data
(60) Provisional application No. 62/052,828, filed on Sep. 19, 2014.

(51) Int. Cl. G06F 19/00; G06F 17/30

(52) U.S. Cl. CPC G06F 19/322; G06F 17/30011; G06F 19/321

(57) ABSTRACT

The problem with healthcare information today is that all of the information used to track a patient's entire encounter is not only stored in disparate systems or databases, but there are individual records or forms that are just stored as paper or images that need to be included as part of the encounter's “total picture.” The search tool links all of these disparate data sets and also converts the paper documents into data text and allows the user to search across all of the information that makes up an episode of care. Users have the ability to query large amounts of multiple data sources into a consolidated view of actionable information with immediate results. This information reduces time and increases the consistency of information for the end user. This can be used on a pre or post pay basis by either the payers or providers, clinical research entities and legal firms. Once the desired information has been found, the individual pages are instantly assembled and collated into a new document and communicated through multiple mediums. From a single episode of care to large data stores of non-discrete medical records can instantly be accessed and queried by non-technical individuals to find decision making information in a time sensitive manner.

This application claims the benefit of U.S. Provisional Patent Application No. 62/052,828, filed Sep. 19, 2014, which is incorporated by reference herein in its entirety.

The field of the invention is the aggregation, normalization, appropriate consolidation and interpretation of healthcare information for the purpose of analyzing and resolving healthcare billing, payment, and patient safety concerns. This invention provides for the capture of discrete and non-discrete data from numerous internal and external (including other facilities) sources and brings all relevant information to one usable, consolidated, common platform to assist in health care claim diagnosis decision making within and across care providers.

### BACKGROUND

Healthcare data lives in multiple unconnected digital data silos and paper based files. Key pieces of information are buried within the system sometimes as discrete, queryable data, sometimes as images and images of documents. This information is used by healthcare payers, providers, and clinical research entities, to monitor, assess and track patient care, utilization of service compliance, financial billing, review of payments and non-payments, patient history, patient eligibility, and many other things. These data, images, and files are commonly not linked together as they may be in different systems, are part of different data sets, while some are individual paper sheets or scanned documents/files perhaps residing outside of any database, system or separate facility. In order to gain full insight to an entire episode of care, all of this information must be accessed, consolidated, and reviewed in order to make time sensitive decisions. This is not possible under the current conditions.

As an example, if a claim for payment has been denied for medical necessity, i.e. the health insurer states that patient did not require the care, a hospital nurse must build a defense of the hospital decisions and actions that justify the care. In this example, the nurse must review clinical information from one or more data sources—likely an electronic medical record; information regarding prior communication and/or authorization from the insurance company—likely from a patient accounting system; information surrounding physician orders—likely from a computerized physician order entry system or dictated notes; images of paper documents—likely in a document image management system; and notes from physicians and case managers—likely in a case management system. All of this data is logically separated and requires different system logins, and/or requires a manual search for documents and then a manual review. The time required to identify the sources of key information, printing or copying the information for review, the actual search and review of the documents is tremendous. It is not uncommon for a complex case medical record to be thousands of pages in length.

Today, healthcare employees have no alternative to consolidate disparate data, automate workflow, or simplify the review and assessment of patient information. Instead they login to multiple systems, read data, toggle and login to other systems, manually search out files, and then copy and print to consolidate data for review. This is both time consuming, a waste of natural resources, and potentially life threatening.

### SUMMARY

It has been discovered that the above stated problems can be resolved by deployment of a tool that consolidates information from disparate sources into a single system, that automates the conversion of imaged documents to discrete queryable data, that has both automated, and user defined targeted health condition research and assessment tools, and then consolidates all of the actionable data and documents into a single electronic version of the events of a patient encounter.

In one example, a computer implemented method for identifying and organizing healthcare claims information comprises the steps of providing a non-transitory computer-readable medium database for storing information about a specific episode of healthcare that is input into it from disparate data sets comprising discrete and non-discrete data. The method further comprises the step of translating healthcare related imaged documents without meta-data that is from a healthcare provider through optical character recognition to create new imaged documents comprising discrete data and saving the new imaged documents in the database. The next steps include loading current and or past patient medical record information data into the database and patient financial system data and electronic medical records data into the database. Further, electronic data interchange data is loaded into the database. Next, the loaded data is translated, if necessary, into discrete data that is searchable and able to be saved according to search query. A subset is created of specific information derived from a search and review of the discrete and translated non-discrete data. Finally, the steps include saving in a separate digital case file in the database all of the discrete data and related document files related to a specific episode of healthcare. The non-discrete document data may be converted to data text. An additional optional step includes loading external data information from public sources into the database and if necessary translating all non-discrete data from the public sources into discrete data. The database receives and stores data in a secure, private method. The external data may comprise industry standard billing, coding and reimbursement guidelines. The method may further include scoring historical results of searches in order to continuously refine the priorities of future searches.

In another example, a system tool that identifies and organizes health care claims information comprises a non-transitory computer readable medium database for storing information about a specific episode of healthcare that is input into it from disparate datasets comprising discrete and non-discrete data. The information comprises patient medical record data including electronic medical record data, patient financial system data, and electronic data interchange data. The tool further comprises a translator for converting the information if necessary into discrete data that is searchable and able to be saved according to a search query. The translator may also convert image documents without metadata, through optical character recognition, into new imagined documents comprising discrete data. Finally, the system tool includes a digital case file in the database comprised of discrete and translated non-discrete data derived from a search of the database and related to a specific episode of healthcare.

### BRIEF DESCRIPTION OF THE DRAWINGS

FIG. 1 is a flow chart illustrating the flow of information data into the database and integral translator.

FIG. 2 is a flow chart that illustrates the aggregation of data based on various search strategies in order to create a library of encounters identified in the stored database.

FIG. 3 is a functional flow chart illustrating the flow of information from a library into a case file and thereafter into correspondence with a payer.

FIG. 4 is a flow chart that illustrates the flow of information from public websites through the tool into a case library.

FIGS. 5-14 illustrate examples of graphic user interfaces that illustrate one example of the tool described herein.

### DETAILED DESCRIPTION

This invention is a tool for the healthcare industry that provides non-technical individuals the ability to search multiple disparate data sets with instant results. This tool is able to take non-electronic data documents and convert those into queryable non-discrete text data. This tool provides the ability to instantly search for information for each claim or episode of care for specific key phrases, words, or acronyms, as defined by a tool user, in order to find commonalities of claim outcomes across multiple data sets. The tool is based on specific information within a specific entity or across an entire industry. The tool provides a rules engine of custom queries for specific services and needs.

Specific pages of documents can easily be identified through this search tool allowing users to ‘stitch together’ a master digital document without the constant print, collate, scan, and print cycle. Payers or providers are able to query data instantly to provide information in a pre-pay and or post pay environment by document type and not just by billed services. This tool captures and translates all data and documents of information for an episode of care in one consolidated location for inventory management of case review, denied and appealed claims and eliminates the dependence on paper for shuffling massive documents.

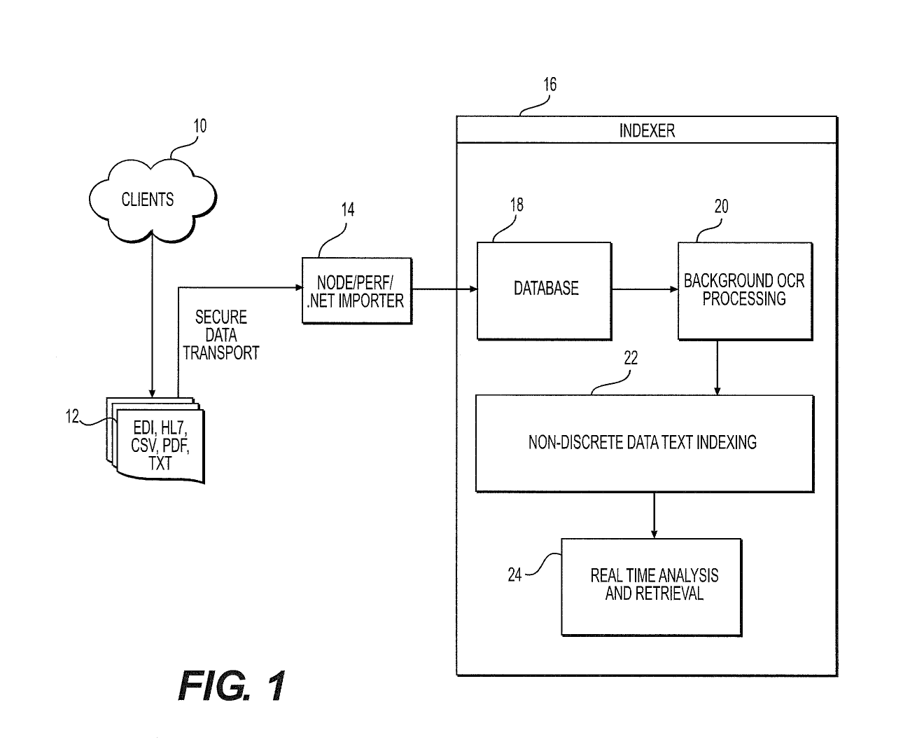

As illustrated in FIG. 1, users of the tool 16 are referred to as clients 10. The clients 10 are typically healthcare providers, payers, clinical research facilities, or attorneys. The clients 10 submit information 12 that they have access to or control over to a system port node 14. The information 12 is sent by secure means as appropriate in view of the individual healthcare information being transferred. The information 12 may be in one, or more typically, several types of data formats. This information is loaded into the database 18. Any imaged documents without meta-data go through an optical character recognition (OCR) process step 20 to translate those specific documents into data. All non-discrete data is instantly indexed 22 and made available immediately for analysis and retrieval 24 with the discrete data in the same database. The indexer 16 denotes the functional conversion of unorganized, indiscrete data into optimized blocks of words and data that may be effectively searched and analyzed.

The terms discrete and non-discrete are used throughout in relation to data that is collected, processed and then analyzed by the tool described herein. Discrete data is, generally speaking, data that unambiguously fits into a specific category or definition. On the other hand, non-discrete data is, generally speaking, not defined and classified with certainty. Using the tool described herein, non-discrete data that is processed by the tool is then able to be reasonably fit into a discrete category or definition that is then searchable and able to be efficiently analyzed by a user.

More specifically, the information 12 comes from at least one or more of the following:
Patient financial system (PFS), Electronic Medical Records (EMR), Document Imaging systems, and other data from systems used by providers are loaded to the tool database. These files could be a historical data set as well as recurring on a go forward basis.
EDI data sets are captured and loaded into the tool database. EDI files may consist of but are not limited to 837 i/p, 835 i/p, and 271 eligibility files that are routinely exchanged by healthcare providers and payers. These files would be historical as well as recurring on a go forward basis.
Employer Benefit Plans and Summary Plan Documents provided from providers, payers, employers, and other sources are housed and loaded into the tool database. Key data elements (date of service, group name, group number, effective dates of the summary plan description, others) would identify and upload the summary plan document to the respective encounter.
Payer, provider, and industry guidelines can be provided and loaded into the database. Key data may be, provider policies, payer contract, clinical guides, inclusions/exclusions for clinical research, coding criteria, and legal documentation.
Documents, meta-data or access to images are made available real-time to capture and convert to discrete or indiscriminate data. Documents to be made available include but are not limited to: Accident Report, Assignment of Benefits, Admit Summary, Appeal Letter, Cover Sheet, Insurance Correspondence, Care Coordination Notes, Discharge Summary, Patient, Driver's License, Department Reports, Divorce Decree, Diagnostic Reports, Eligibility Print Out, EMS Report, EOB, Emergency Room Report, Medical Record, Hospital Collection Notes, History and Physical Report, Itemized Bill, Insurance ID Card, Medication List, Nurses Notes, Operative Report, Payer Contract, Summary Plan Document, Progress Notes, Doctor's Orders, Pre Authorization, UB-04, Skilled Nursing Facility Agreement, Claim History Notes, CMS 1500, Facing Summary, EDI Transmission Report, Invoice for Skilled Nursing Facility, Invoice for Date of Service, Health Safety Net Recoup, Retraction Remit, Letter From Patient, Police Report, Physical Therapy Notes, and Skilled Nursing Facility Collection Notes.
Information data sources are labeled and categorized through a tagging mechanism allowing for the quick identification of similar components across appeals. Examples include tagging the Progress Notes in the Medical Record document or tagging the entire encounter with a saved search result.
Documents are saved to the tool data structure and converted to data text.

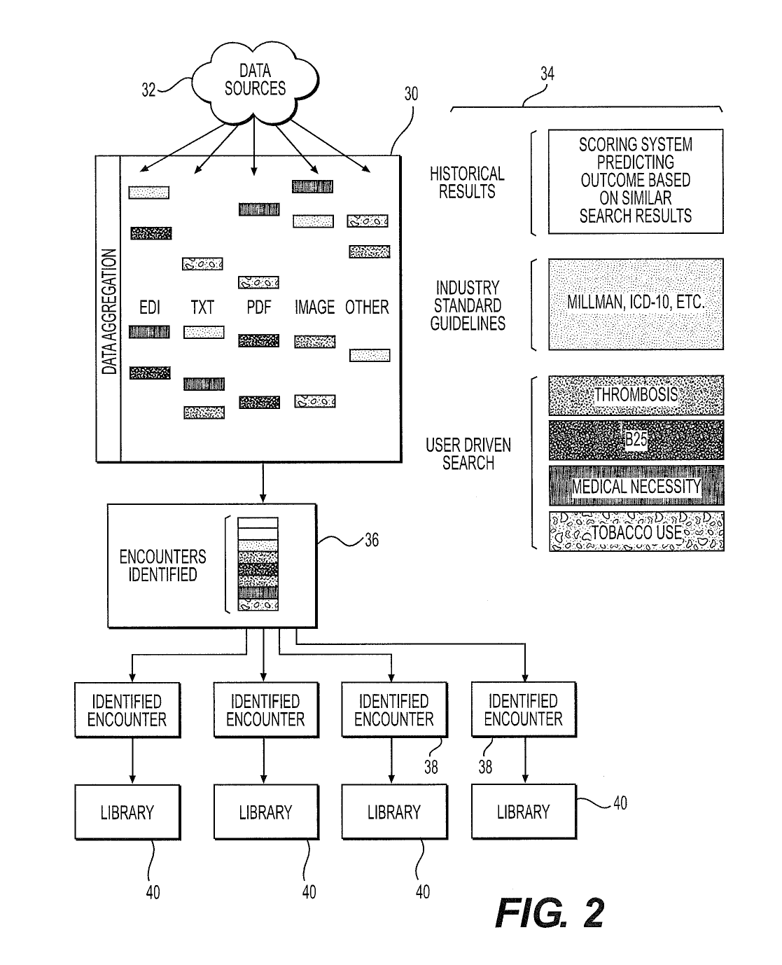

In FIG. 2, the tool database 30 contains multiple data sources 32 as shown. The user enters search criteria 34 across the normalized and aggregated sources of data 32 in order to extract the desired encounters 36. The tool allows the user to enter the criteria and also utilize industry standard informational guidelines to conduct the search criteria. Individual identified encounters 38 are then placed in separate library 40 folders. The tool also captures past results and outcomes and utilizes this intelligence in order to score and prioritize encounters to be reviewed by the user. This capability does not exist today in the market place.

Specific examples of how the search is undertaken include the following:
Documents (images and converted text)/835/837/PFS/EMR/other data are linked together through key data elements in order to create a casework of the encounter.
Users can search/query by virtually any element or combination of elements in order to find the patterns within a specific case or across the entire database of information. One example of this searchable function are for claims where the insurance company has denied a spinal fusion hospital procedure as an Experimental or Investigational procedure. In order for the hospital staff to efficiently determine if they should appeal the claim, they would use this invention to find instances across the entire clinical, historical, data store where the billing code was for spinal fusion, the denial was for Experimental/Investigational the Operative Notes and Medical Records state it was for an anterior fusion, not posterior fusion. By searching these multiple sources of disparate data sets and paper documents the hospital staff can immediately determine claims to appeal or not appeal based on the multiple criteria entered i.e. billing code (DRG 437 in the EDI 837 data), denial code (Remark code 623 in the EDI 835 data), Operative Note and Medical records (anterior or posterior verbiage stated in the EMR, discrete or non-discrete data from other systems stored as scanned images). With the industry supporting Anterior spinal fusions as reimbursable, the individual pages of the documents that provide the hospital case for appeal are then easily identified and assembled as its own document for the hospital associate to appeal the claim back directly sent from the tool via email, fax, or exported to mail to the insurance company for proper payment.

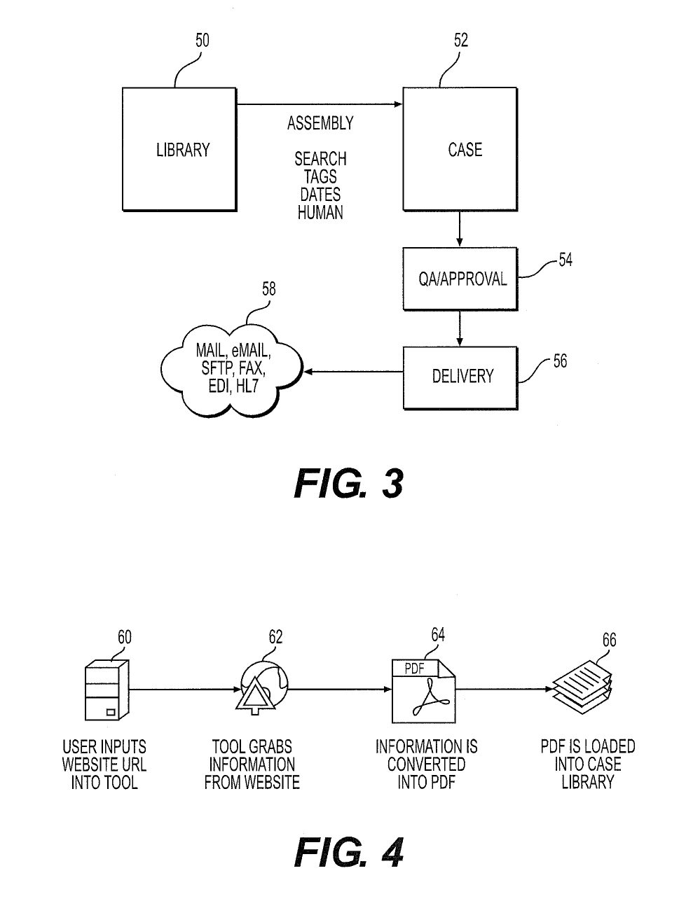

Turning now to FIG. 3, each healthcare episode is assigned a library 50 of documents that the user may need to include in proving their individual case 52 to the payer or provider, depending on the end user. The library 50 is comprised of documents associated with an episode of care. A case 52 is quickly assembled using a compilation of the documents identified by searching for key words, identifying a specific or array of dates, document tags, and/or by an individual user. Once the case has been assembled, it is submitted to a QA work queue 54 where a user verifies the appropriate delivery method 56 of the case and that all appropriate documentation has been included. The case 52 is then delivered through mail, email, SFTP, fax, HL7, EDI, and or other secure methods 58.

Other uses and aspects of the use of library and an assembled case includes the following:
Contract managers and ERISA attorneys can utilize tool to search for Summary Plan Descriptions; contract language relative to timely filing limits; retroactive authorization opportunities; potential underpayments in pricing and timing of contract terms and rate changes. As an example, enter into tool specific dates in question to confirm contract timing and pricing.
With industry data and industry standard billing, coding, reimbursement guidelines, queries can be predefined by the tool in order to find patterns related to Billing, Overpayments, Underpayments, Denials, and Patient Care, used prior, during or after the services have been rendered by either insurance payer or providers of care.
Predefined search criteria are applied to search for specific words and data in order to check for similar cases. Users will be able to check for Severity of Illness with words like dropped, increase, maintained, etc.
Physicians are able to take all of the information from a patient history and easily create a summary of the pertinent information in order to quickly view desired key information of their patient health record.
Multiple physicians and providers in different geographic locations can supply a single patient's entire historical medical record to other care physicians and providers in order to have a complete patient continuity of care across episodes of care.
Claim Billers can utilize this tool in order to consolidate the documents and data to bill or re-bill claims through, for instance, the Appended Documents 275 EDI transaction set.
Hospitals, physicians and other providers may utilize third party document storage and retrieval companies in order to manage the use of their documents. When documents are requested, the provider and or the third party must find all of the related documents being requested and then must confirm that only the appropriate documents are included prior to release of any information. This tool can store the documents and provide the user the ability to query the documents and use predefined search criteria significantly reducing the time to confirm only the appropriate documents are provided and any inappropriate documents have been excluded. Since documents can be shared with multiple users, accessing the need to transfer documents from one entity to another may be reduced or eliminated altogether.
Consumers, patients and family members generally could utilize the tool on a conventional CPU, laptop, tablet, or as an app on a mobile device. These users might be involved in a payment process, or additionally, could use the tool as a source for medical information and specific patient medical history.

FIG. 4 illustrates the process of pulling public information into the tool. This tool 60 can link to a URL on the internet in order to intake 62 a “snapshot” of a specific page or specific information including pictures, text, and graphs. This information can then be translated into pdf format 64 and appended into the tool allowing the user to immediately add the acquired text or objects into the case library 66 being created by the user and are then stored as a .pdf within the case.

Greater detail with respect to building and using the healthcare data management tool is provided in the following discussion.

### Step 1: Database Build

Portable Document Format (PDF)—The tool database is built in such a way that it can scale regardless of document size. PDF files are broken into manageable chunks. This affords flexibility when dealing with massive 500+ page documents.
1. Upload PDF documents to the database. During the upload process, the document is split into individual pages. Each page contains a unique id and a sequence number in order to logically re-assemble it when a user requests this. The sequence number can be thought of as the page number.
2. The page is actually stored as an object within the database record rather than stored as a file on a separate system.
3. After the page has been stored (including the appropriate meta-data to tie it back to a particular case), it is eligible for the OCR queue. This is a background process that systematically optimizes each PDF as a high contrast TIFF file and decodes the image into real text. The text is then saved as a database element.
4. Immediately following this, an indexer sweeps through the saved text and optimizes it for a free form text search.
5. These ‘pages’ tie back to a case by including two pieces of information:
   a. NPI—National Provider Identifier
   b. Encounter Number—A unique number within that provider that encapsulates anything the patient underwent between admission and discharge.

Electronic Data Interchange (EDI)—This includes X12 standard formats such as 835 (claims paid electronically from payers), and 837 (claims submitted electronically from providers) as well as HL7 (electronic health information including documents) data. The tool is able to store the EDI data in its native format allowing it to be searchable as either discrete on non-discrete elements. These industry standard documents carry valuable information about provider and payer interactions. Other EDT documents also carry remittance information critical to understanding the relative value of one type of claim over another.

Text (csv)—In many cases, exports from remote systems are handled as csv or pipe delimited text files. The tool is able to bring this data into the same searchable context.

Images—Images often times include screenshots of clinical systems. The text on these screenshots often contains valuable information. Images are embedded into a PDF to preserve page size for future operations and the contents of images are run through OCR to produce text that can be searched.

Other—Any other data or image source that can be captured from internal or external third party data or information can be indexed and tied to a case in order to use as searchable information.

### Step 2: Importing Data to a Library

### Manually

A simple drag and drop interface on a web browser allows individuals to import all file types from their corporate network or desktop.

### Automated

A suite of export tools for various EMR and Document Management systems allow the tool to trigger the export of entire documents associated with specific cases. This process adds a layer of efficiency because it does not rely on people to perform the routine work of accessing the documents and manually placing them in a library or case file.

### External Data Sources

The tool can provide URL shortcuts. These include desired Websites, Industry standard guidelines, payment rates and guidelines, or purchased online software where either a “snapshot” of information can be taken and then imported into the Library as an image or as data. Any external non-meta data information is converted to .pdf and becomes searchable information.

Step 3: Search Key Data—Create Episode Case File from a Library

### Historical Results

The tool timestamps the creation, submission, and delivery of the case documents. Additionally, the dollars affected by the case are tracked or entered into the database. The outcome of a case is measured and scored using key words located within the case, the timeframe of creating the document, the dollar amount of the claim, among others associated with the case. Similar cases are then grouped through the key words within the case and are linked together to create the scoring system that projects odds and success ratios for future cases. This scoring system is integrated into the search results allowing users to project timeframes and success rates for cases with the similar criteria. This scoring methodology also creates a priority of cases to be reviewed by the users.

### Industry Standard Guidelines

Databases and documents housing industry standard guidelines are linked to the tool and integrated into the search function. For instance, Milliman Care Guidelines (MCG) is an industry standard used by payers and providers to determine whether a claim meets medical necessity guidelines. The search tool would access the criteria outlined by MCG, and then, in an automated process help determine whether a claim was medically necessary. This decreases the time spent on the claim triage process for payers and providers. For example in a Delay of Discharge denial for an electrophysiological study, this tool would search the MCG criteria outlined for an extended stay circumstance. This tool would search across the different criteria needed for monitoring of the patient's discontinuing antiarrhythmic agents before the electrophysiological study. A negative search result indicates a denial of medical necessity due to a delay in discharge. A positive search result indicates MCG criteria was met and the claim cannot be denied for a delay in discharge. Additional guidelines that may be integrated similarly as MCG into the tool include: FDA guidelines, payer guidelines, ICD-10, and additional coding guidelines.

### User Driven Search

A user can search across multiple documents by identifying key words, phrases, and dates. Additionally, the user limits their search by identifying specific documents they want to search within a case by indicating how that individual page should be tagged. For instance, a provider may have a denial for an outpatient procedure that billed at an inpatient rate. Industry guidelines indicate the physician order must specifically indicate inpatient admission. So a user would want to limit a search on the key word “inpatient” to the physician orders. Another example would be that a provider might search the insurance denial letter to determine which MCG reference was applied to a medically necessity denial, then link that code to the MCG guidelines to indicate which procedure and diagnosis codes are associated with that specific code, and lastly link it back to the electronic data interchange data (EDI) to determine whether the appropriate DRG code was applied to the claim.

### Step 4: Assembly

Once the search is completed, the User is able to create a new document by merging multiple documents or individual pages of multiple documents. Once the new document is created the User can then move the individual pages to the desired order to finalize the document. Embedded templates are also available for specific cover pages that may be desired by the User.

### Step 5: Delivery

A final step of this process is the delivery of a completed document relating to a specific episode of healthcare. In many cases the documents are very large (1000+ pages). As such, there are a variety of internal resources required to print and mail these documents. Surprisingly, hard copy receipt of documents is still a preferred delivery mechanism for a certain class of recipients. However, this tool can send documents via fax, email, SFTP or standard mail into a series of keystrokes delivering the documents electronically, obviating the need for any other steps. It is as easy to mail a 1,000 page document as it is to email it with this tool.

### Reporting

### User Examples

### Provider Use Detailed Example—(Sample Search Criteria is Italicized)

XYZ provider is in receipt of kidney transplant claim denial not meeting medical necessity (Remark Code M76 on EDI 835) from ABC Insurance Company. The denial remark codes indicate the claim is denied because symptomatic uremia is not indicated as a diagnosis on the billed (diagnosis category 585 on EDI 837) claim.

The user reviews the denial and researches ABC Insurance Company's policy (PDF), via the tool, for indications of symptomatic uremia. The user finds that symptomatic uremia is indicated in ABC Insurance Company's kidney transplant policy. The user refers the claim and medical documentation, via tool, to a nurse for review of patient clinical documentation that supports uremia.

Via the text search tool, the nurse searches documents that indicate uremia and does not find anything specific to said terminology. Given the nurse's clinical knowledge, she begins to search across all documents in tool to secure supporting documentation for determining if a patient has uremia and its treatment as provided below from multiple medical/clinical published sources:
The dialysis treatment recorded one day prior to admission indicating:
Hemoglobin (Hgb)=9. Anemia is symptom or uremia.
Patient complaint of nausea without vomiting; leg cramps, and generalized weakness. Each of the indicated symptoms are consistent with uremia.
Pre-operative lab values consistent with uremia and submitted on appeal,
Creatinine Clearance-7
Glucose-200
Hgb=9
Hematocrit (hct)=27.2
Ferritin level=14
Ammonia=84
Phosphate-2.2
Sodium (Na)-100
History & Physical documents indicate patient is being admitted for transplant. Present History (PH)=ESRD; CHF; Type 1 Diabetes. Dialysis=2 years.

### Insurance Payer Uses

Payer Healthcare users include: cost containment department professionals; medical staff such as physicians and nurses; audit staff which are healthcare financial analysts; clinical professionals; network managers; and attorneys. Network managers and attorneys will utilize the tool to review, distribute, and finalize contract versions. Use of the content text as a search feature will surface words, phrases, and contract versions for contract information and language such as: drug outliers; dollar threshold; first dollar; timely filing limits; out clause to name a few.

### Insurance Payer Uses Detailed Example

ABC Insurance Company received a claim from XYZ provider which indicates the patient received a kidney transplant at their facility on Jan. 1, 2014. It is the policy of ABC Insurance company that all claims >$50K are to be reviewed by the Cost Containment Department Director prior to payment. The Director begins by confirming the patient has active insurance coverage with ABC Insurance Company. Next, the Director confirms via the tool that an authorization was in place prior to said services being rendered. Authorization number on the claim is 123456789. Next, is XYZ provider contracted with ABC Insurance Company. The Director confirms in the tool that XYZ provider is a contracted provider with ABC Insurance Company. All of the above results are confirmed via the tool and are in place.

Next, the Director confirms that each of the kidney transplant criteria (ABC Insurance Company Transplant Indications are listed below) has been followed by XYZ provider via guidelines loaded in tool. The Director does not see uremia indicated as a diagnosis on the claim, hence denies the claim as not medical necessary. XYZ provider now has the responsibility of explaining the medical necessity indications that led to the transplant.

### Transplant Indications

End-stage Renal Disease (ESRD):
Chronic renal failure with a Glomerular Filtration Rate (GFR)<20 ml/min
Chronic renal failure on dialysis
Symptomatic uremia
Anticipated ESRD as defined above within next 12 months (preemptive transplantation)
Combined liver/kidney transplant when one or more of the following are present: (Eason et al)
ESRD patients with cirrhosis and symptomatic portal hypertension or hepatic vein wedge pressure with gradient >10 mm Hg.
ESRD and Chronic Kidney Disease (CKD) with GFR ≦30 ml/min
Patients with acute renal insufficiency including hepatorenal syndrome with creatinine ≧2 mg/dl and dialysis ≧8 weeks
Patients with ESRD and evidence of CKD and kidney biopsy demonstrating >30% glomerulosclerosis or 30% fibrosis.
Combined heart/kidney transplant (Russo et al and Gill et al)
Low risk patients with ESRD or CKD with eGFR <33 ml/min. Refer to Medical Director.
Re-transplantation. Usually due to primary non-function, rejection, recurrent disease and/or immunosuppression toxicity.

### Clinical Research Example Utilizing Across Case Functionality

The tool described herein is able to search across 1 or millions of data or paper converted documents. This ability provides a unique opportunity for clinical research across large databases of patient history.

### Clinical Trials Exclusion Criteria

This tool will surface inclusion and exclusion criteria for a given clinical trial and surface patients and documentation quickly for a provider's review. Doing so, the tool acts as a decision tool that will quickly allow providers to determine if the trial would be suitable for their business and if there are a sufficient number of individuals meeting the inclusion criteria.

As an example, there is an active clinical trial for clinically nonfunctioning pituitary adenomas.

### Inclusion Criteria:

Adult patients with pituitary lesions that do not require surgical intervention
Pituitary lesion that has been demonstrated on MRI to be consistent with an adenoma
Patients with macro adenomas >1 cm or large micro adenomas 6-9 mm.
A prolactin level <40 ng/ml

### Exclusion Criteria:

Presence of visual or neurological deficits due to the tumor. Tumor impingement on the optic chiasm and physical or laboratory abnormalities consistent with a biologically active hormone secreting tumor.

The tool searches key words to surface documents within the words or phrases selected. Beginning with pituitary AND lesion AND MRI AND optic chiasm. The search surfaces and indicates that the MRI report reflects mild compression of the optic chiasm, hence the patient would not be a candidate for this particular trial.

### Attorney Example

ABC Hospital, Attorney's Client, provides a sizeable volume of claims which XYZ Workers Compensation Company has consistently not paid for.
ABC Hospital provided attorney with access to all administrative documents, correspondence, and medical records needed.
Attorney's paralegal spent days, equivalent to a 40 hour work week, going through the documentation to find incident reports, administrative documents and correspondence, medical record documentation pertinent to the workers compensation injury in question (there was more than one injury per patient) to begin review.
With hundreds/thousands of pieces of paper in hand, attorney and staff can begin to determine priority review which is reading each case one by one to determine next steps.

### Tool Utilized:

Tool searches across multiple cases to find the incident report on each. Located on page 98 out of 1,000. A quick review shows that each are signed by patient and employer. Only phone calls have to be placed on two of the patients to obtain their incident reports.
ABC Hospital indicates they have not been paid by the workers compensation carrier on any of the patient claims provided.
The tool searches through critical data elements (billing criteria such as payer, DRG, diagnosis) to determine if there is a pattern. The pattern surfaced; a specific employer, and any fracture cases were not paid.
The attorney's next step is to reach out to the employer to determine why so many fractures and begin to understand the incidents occurring.
Tool's time spent in loading, searching, and trending 1,000 pages of multiple documents was less than one hour.
A letter is generated to employer with stated findings and expected next steps and each of the documents surfaced and trended are electronically assembled in a single repository and correspondence and results are tracked.

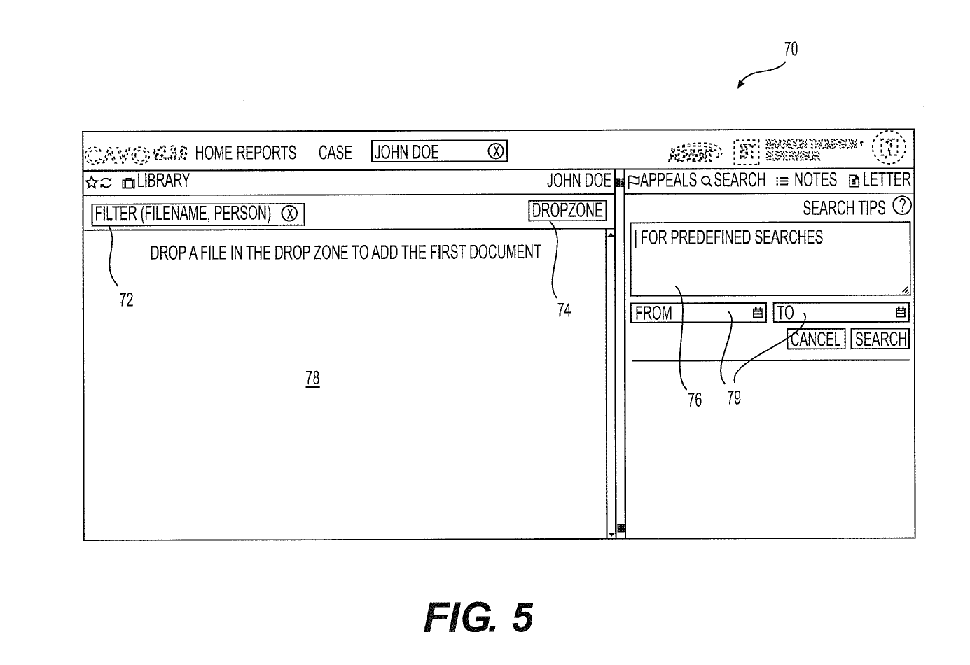

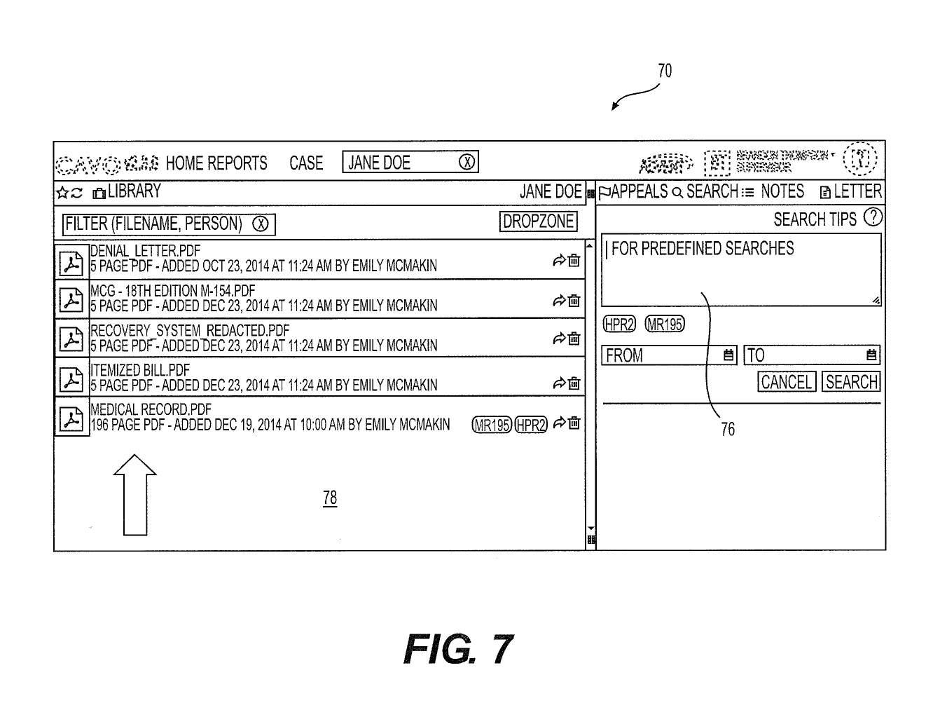

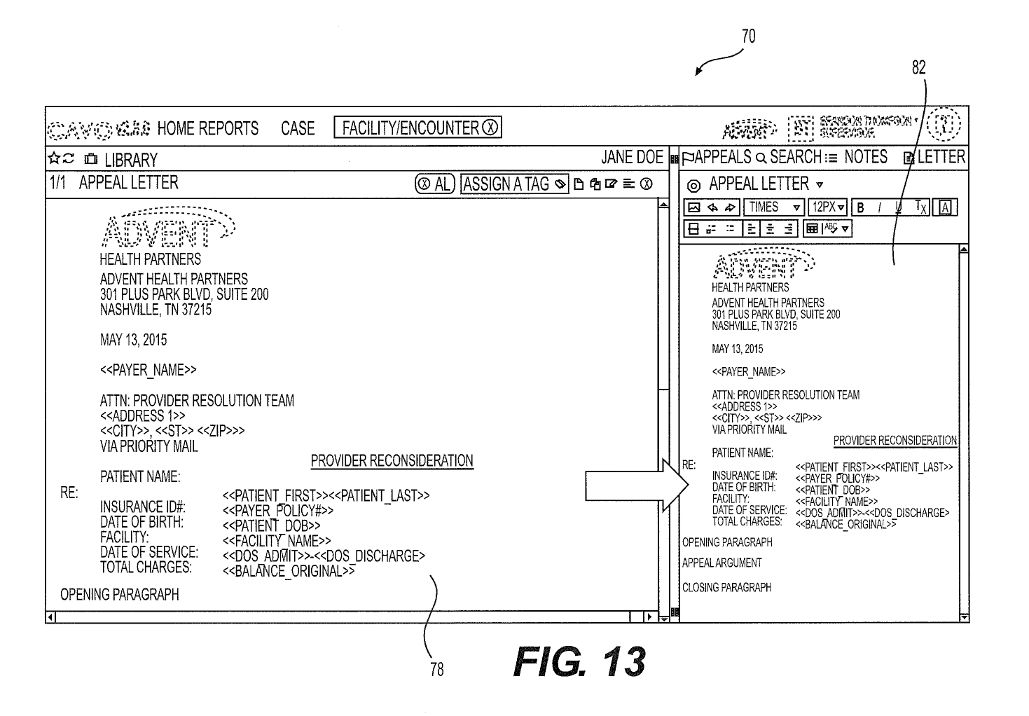

FIGS. 5-14 illustrate alternative views of a graphic user interface 70 that is the visual output of the healthcare data management tool described herein. These are merely a selection of some of the numerous interfaces that could be seen by a user in the ordinary course of interaction with the tool.

Turning first to FIG. 5, an empty user interface 70 is shown. That is, there are no files in the drop zone 78. The filter 72 is a way to address a specific file by file name or by person name. The drop zone button 74 allows files to be intuitively moved and placed into the drop box. The search box 76 is available for both custom searches and predefined searches. Finally, date boxes 79 allow a time sensitive search.

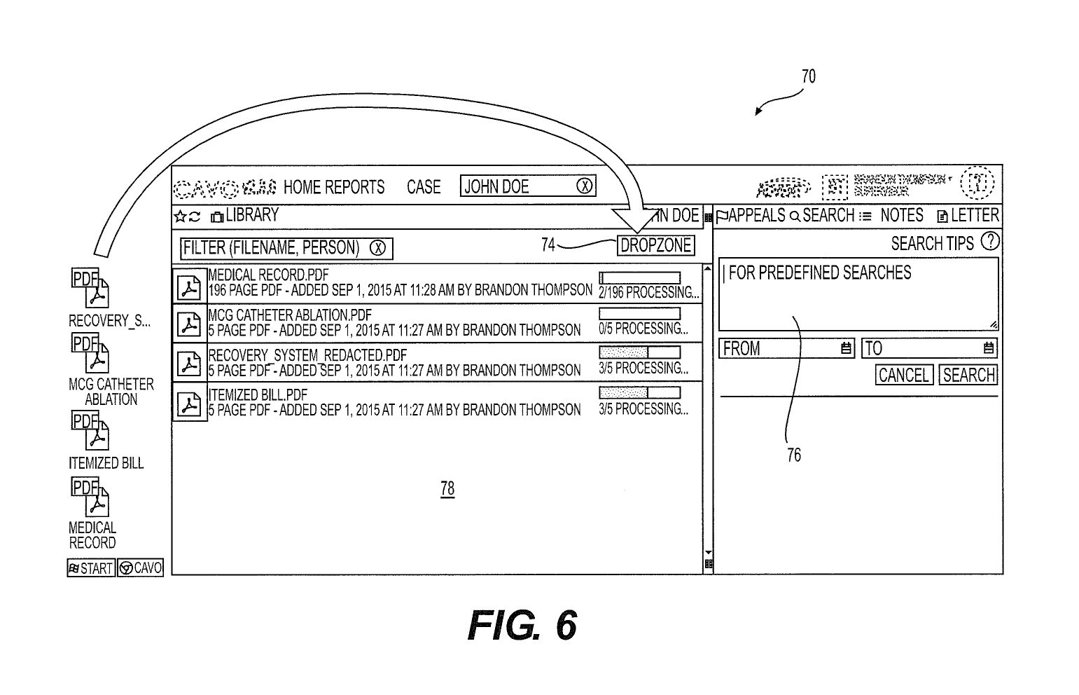

In FIG. 6, files are shown in the library 78 after being transferred into that library through the drop zone box 74. There is still no search as evident from the search box 76. After the documents have been placed in the library 78, it can be seen that there were 5 documents in the file including more than 220 physical pages of materials.

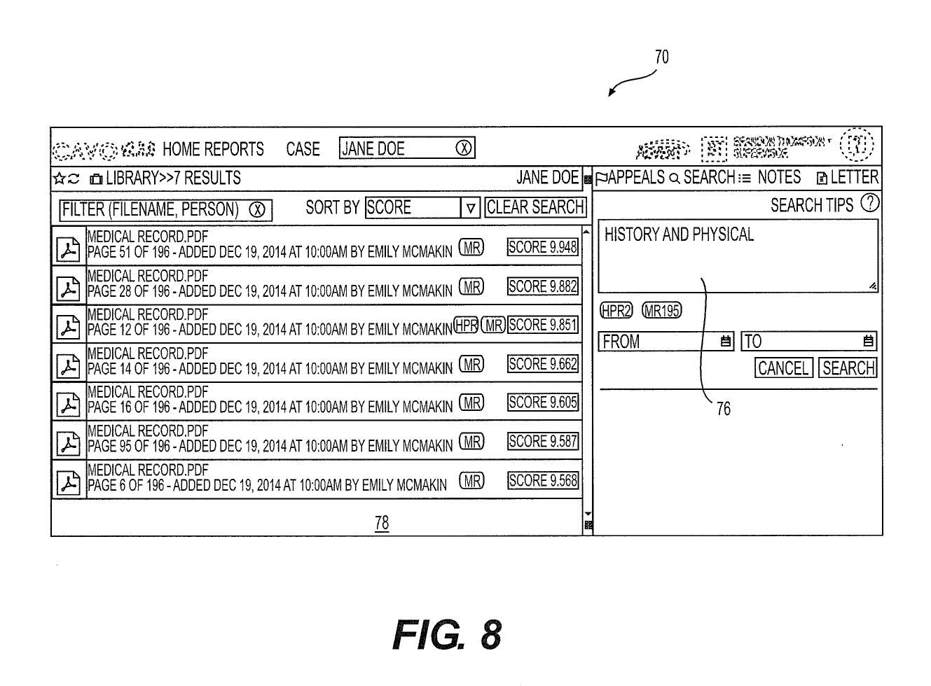

In FIG. 8, search parameters are input in the search box 76 and identify 7 search results in the library file 78. FIG. 8 indicates a custom, manual search with a pair of key terms only.

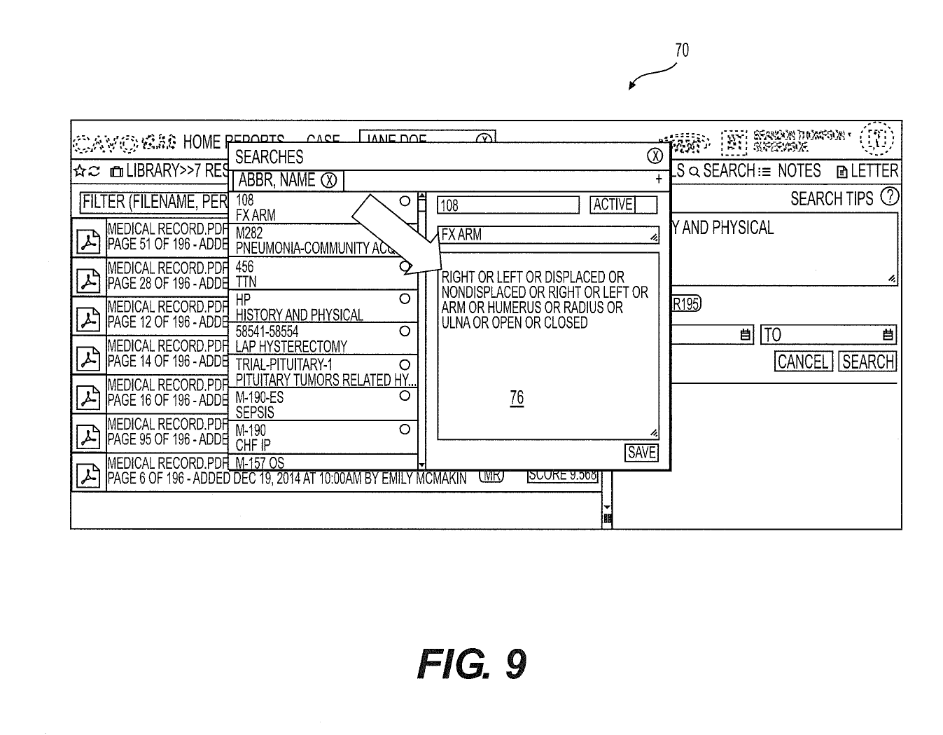

FIG. 9, a pre-defined search query is illustrated in search box 76. The predefined search query is directed to a fractured arm. Default terms are immediately used to search the documents in the library.

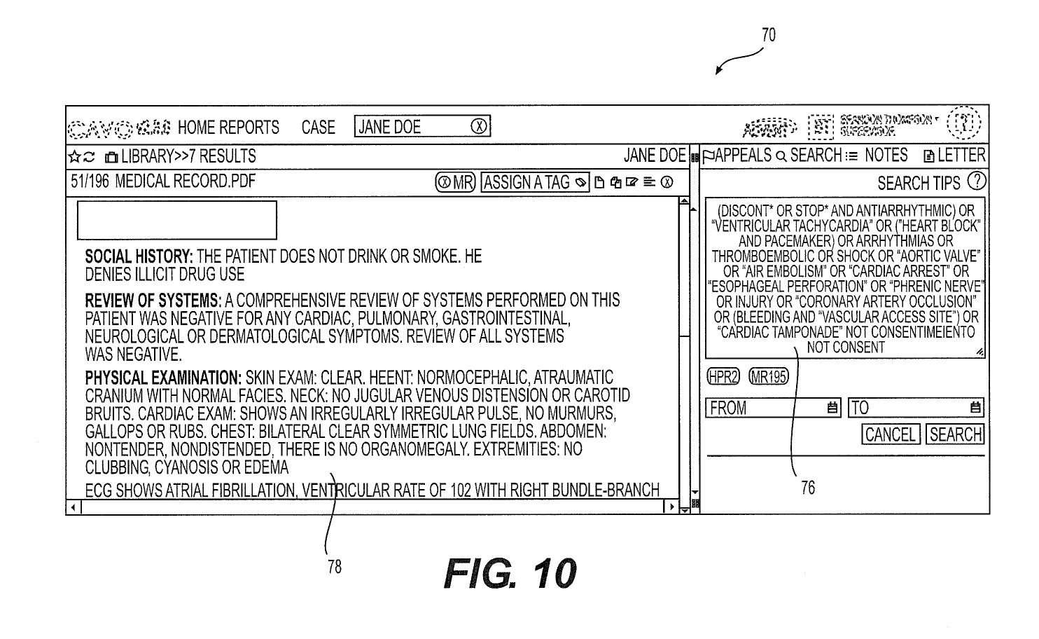

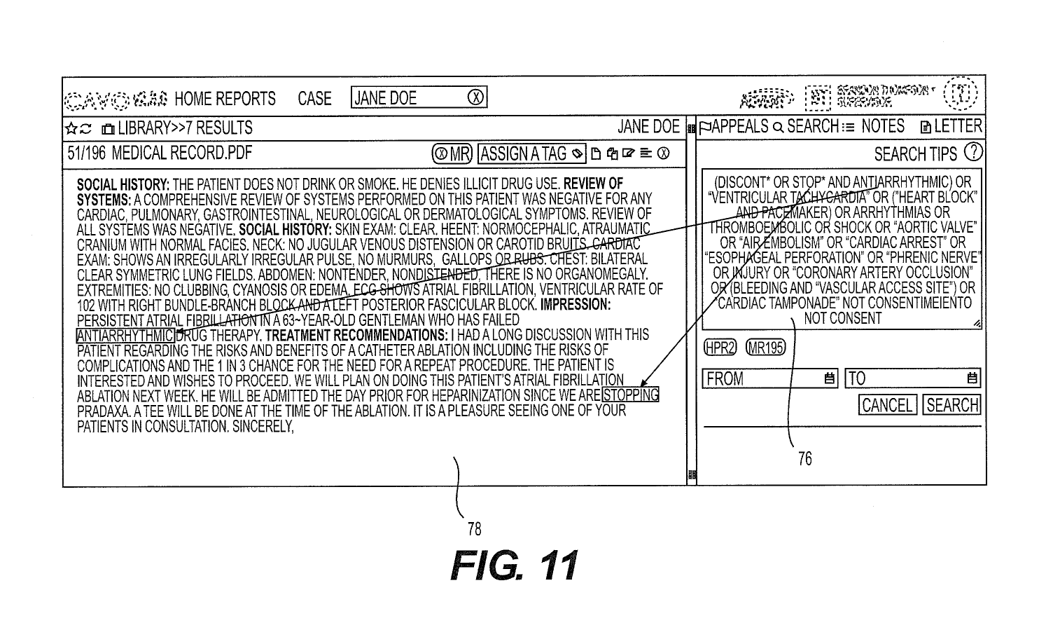

In FIG. 10, the search parameters in the search box 76 identify a specific document relevant page in the library 78. Alternatively, instead of the view of the actual document as shown in FIG. 10, in FIG. 11, the text is displayed only with the highlighted results from the search.

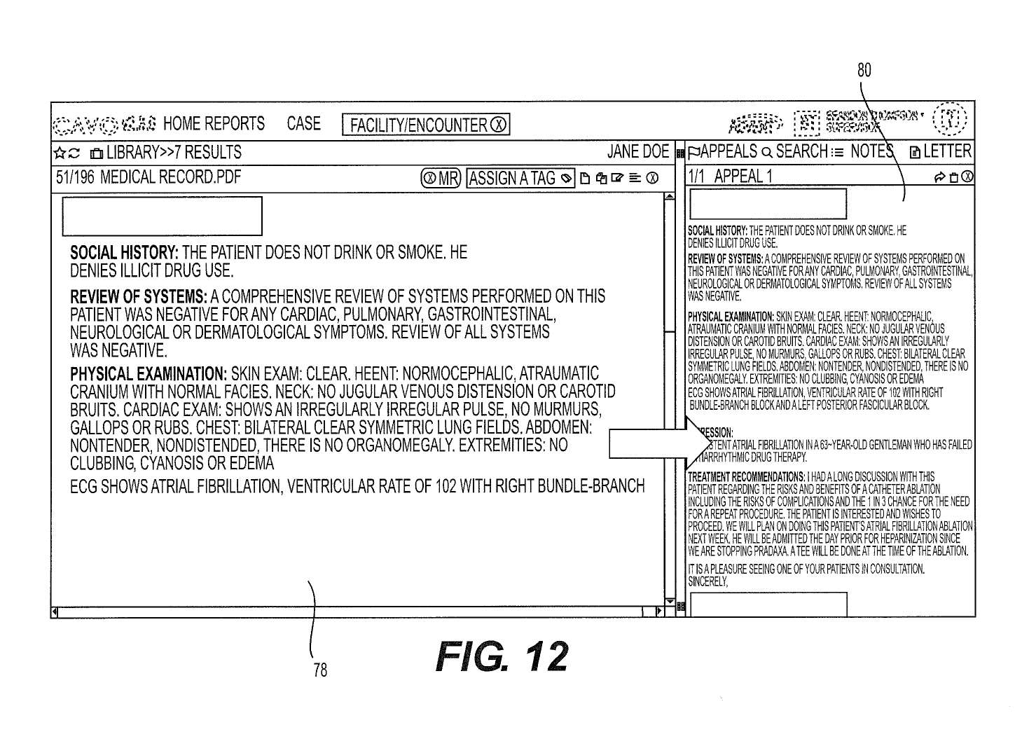

In FIG. 12, a user assembles individual pages of the Library documents into an entirely new document as an appeal file 80. The appeal file would then be collected and assembled with a document/appeal as shown in the library 78 and the appeal letter file in box 82.

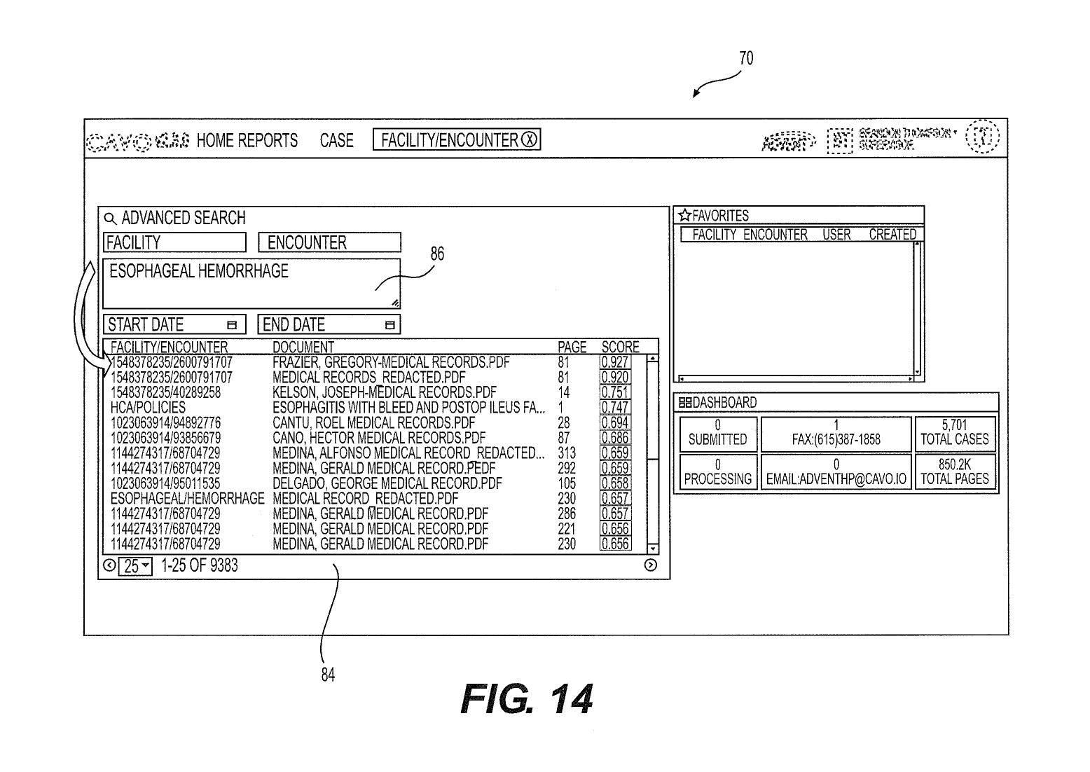

Finally, in FIG. 14, there is a demonstration of the ability to search across multiple case files. This search 86 turns up multiple case files 84 that may themselves be individually searched for appropriate information.

Other embodiments of the present invention will be apparent to those skilled in the art from consideration of the specification. It is intended that the specification and figures be considered as exemplary only, with a true scope and spirit of the invention being indicated by the following claims.

What is claimed is:

1. A computer-implemented method for identifying and organizing healthcare claims information, the method comprising the steps of:
providing a non-transitory computer-readable medium database for storing information about a specific episode of healthcare that is input into it from disparate data sets comprising discrete and non-discrete data;
translating healthcare related imaged documents without meta-data that is from a healthcare through optical character recognition to create new imaged documents comprising discrete data and saving the new imaged documents in the database;
loading patient medical record information data into the database;
loading patient financial system data and electronic medical records data into the database;
loading electronic data interchange data into the database;
translating, if necessary, the loaded data into discrete data that is searchable and able to be saved according to search query;
creating a subset of specific information derived from a search and review of the discrete and translated non-discrete data;
saving in a separate digital case file in the database all of the discrete data and related document files related to a specific episode of healthcare.

2. A computer-implemented method as described in claim 1, wherein the non-discrete document data is converted to data text.

3. A computer-implemented method as described in claim 1, further comprising the steps of loading external data information from public sources into the database, and if necessary, translating all non-discrete data from the public sources into discrete data.

4. A computer-implemented method as described in claim 1, wherein the database receives and stores data in a secure, private method.

5. A computer-implemented method as described in claim 3, wherein the external data comprises industry standard billing, coding and reimbursement guidelines.

6. A computer-implemented method as described in claim 1, wherein the digital case file comprises one or more of the following classes of documents selected from the group consisting of:
accident report, assignment of benefits, admit summary, appeal letter, cover sheet, insurance correspondence, care coordination notes, discharge summary, patient, driver's license, department reports, divorce decree, diagnostic reports, eligibility print out, ems report, BOB, emergency room report, medical record, hospital collection notes, history and physical report, itemized bill, insurance id card, medication list, nurses notes, operative report, payer contract, summary plan document, progress notes, doctor's orders, pre authorization, ub-04, skilled nursing facility agreement, claim history notes, CMS 1500, facing summary, EDI transmission report, invoice for skilled nursing facility, invoice for date of service, health safety net recoup, retraction remit, letter from patient, police report, physical therapy notes, and skilled nursing facility collection notes.

7. A computer-implemented method as described in claim 1, wherein the database is adapted for use by a user selected from the group consisting of a service provider, a medical provider, an insurer, and an insured.

8. A computer-implemented method as described in claim 1, further comprising the step of:
communicating the digital case file information via electronic media to care providers to ensure a patient continuity of care.

9. A computer-implemented method as described in claim 1, further comprising the step of:
scoring historical results of searches in order to continuously refine the priorities of future searches.

10. A system tool that identifies and organizes healthcare claims information comprising:
a non-transitory computer-readable medium database for storing information about a specific episode of healthcare that is input into it from disparate data sets comprising discrete and non-discrete data;
wherein the information comprises patient medical record data including electronic medical record data, patient financial system data, and electronic data interchange data;
a translator for converting the information if necessary, into discrete data that is searchable and able to be saved according to a search query;
a translator for converting imaged documents without meta-data, through optical character recognition, into new imaged documents comprising discrete data; and
a digital case file in the database comprised of discrete and translated non-discrete data derived from a search of the database and related to a specific episode of healthcare.

11. A system tool as described in claim 10, wherein the database further stores external data information from public sources.

12. A system tool as described in claim 11, wherein the external data information comprises industry standard billing, coding and reimbursement guideline.

13. A system tool as described in claim 11, wherein the database receives and stores data in a secure, private method.

14. A system tool as described in claim 10, wherein the digital case file comprises one or more of the following classes of documents selected from the group consisting of:
accident report, assignment of benefits, admit summary, appeal letter, cover sheet, insurance correspondence, care coordination notes, discharge summary, patient, driver's license, department reports, divorce decree, diagnostic reports, eligibility print out, ems report, EOB, emergency room report, medical record, hospital collection notes, history and physical report, itemized bill, insurance id card, medication list, nurses notes, operative report, payer contract, summary plan document, progress notes, doctor's orders, pre authorization, ub-04, skilled nursing facility agreement, claim history notes, CMS 1500, facing summary, EDI transmission report, invoice for skilled nursing facility, invoice for date of service, health safety net recoup, retraction remit, letter from patient, police report, physical therapy notes, and skilled nursing facility collection notes.

15. A system tool as described in claim 10, wherein the database is adapted for use by a user selected from the group consisting of a service provider, a medical provider, an insurer, and an insured.
